(19) United States
(12) Patent Application Publication
(10) Pub. No.: US 2008/0305210 A1
(43) Pub. Date: Dec. 11, 2008

(54) Cultures Encapsulated With Compound Fat Breakfast Cereals Coated With Compound Fat and Methods of Preparation

(75) Inventor: Warren Petersen, Maple Grove, MN (US)

Correspondence Address: GENERAL MILLS, INC., P.O. BOX 1113, MINNEAPOLIS, MN, 55440, US

(73) Assignee: GENERAL MILLS, INC., Minneapolis, MN (US)

(21) Appl. No.: 11/570,617

(22) PCT Filed: Jun. 21, 2005
(86) PCT No.: PCT/US05/21881

§ 371 Date: Jul. 25, 2008

Related U.S. Application Data
(60) Provisional application No. 60/584,722, filed on Jul. 1, 2004.

(51) Int. Cl. A23D 7/005

(52) U.S. Cl. 426/61

(57) ABSTRACT

Food products are provided comprising a food base and the compound fat encapsulated pro-biotic as a coating or portion or phase of the food product. The food base can include the compound fat encapsulated pro-biotic as a topical coating or phase or portion. The food base or foodstuff is dried and has a water activity ranging from about 0.1 to about 0.35. The weight ratio of food base to compound fat encapsulated pro-biotic ranges from about 100:1 to about 100:400. The pieces of the coated food base can be admixed with pieces of uncoated dried food base of the same or different composition to provide desired levels of pro-biotic fortification

### CROSS-REFERENCE TO RELATED APPLICATIONS

This application claims the benefit of priority under 35 U.S.C. 119(e)(1) of a provisional patent application, Ser. No. 60/584,722, filed Jul. 1, 2004 and of the PCT international application designating the United States of America, Serial Number PCT/US05/21881, filed Jun. 21, 2005, which are incorporated herein by reference in its entity.

### BACKGROUND OF THE INVENTION

The present invention relates to food products and to their methods of preparation. More particularly, the present invention relates to live cultures such as yogurt or probiotic cultures encapsulated in a compound fat to provide “loaded” or inoculated compound fats, to food products bearing or coated with such “inoculated” compound fats such as breakfast cereals, and to methods of preparation of such inoculated compound fats and food products.

Probiotic micro-organisms are micro-organisms which beneficially affect a host by improving its intestinal microbial balance. In general, it is believed that probiotic micro-organisms produce organic acids such as lactic acid and acetic acid which inhibit the growth of pathogenic bacteria such as Clostridium perfringens and Helicobacter pylori. Probiotic bacteria are therefore believed to be useful in the treatment and prevention of conditions caused by pathogenic bacteria. Further, probiotic micro-organisms are believed to inhibit the growth and activity of putrefying bacteria and hence the production of toxic amine compounds. It is also believed that probiotic bacteria activate the immune function of the host.

There is considerable interest in including probiotic micro-organisms into foodstuffs. For example, many fermented or inoculated milk products are commercially available that contain probiotic micro-organisms. Usually these products are in the form of yogurts or inoculated pasteurized refrigerated fluid milk. Indeed, yogurt per se is considered to be a good source of such live and active probiotic cultures. Also, several infant and follow-up formulas which contain probiotic micro-organisms are also commercially available; for example the BIO NAN.®. formula (Societe des Produits Nestle SA). Typically, these products have high water activity values (e.g., greater than 0.9) and thus provide a moist environment in which moisture is available to maintain the cultures as live and active or viable for the duration of their limited refrigerated shelf life (of generally less than sixty days).

Similarly, for animals, there has been interest in including probiotic micro-organisms into animal feeds. See for example U.S. Pat. No. 5,968,569 “Pet Food Product Containing Probiotics” (issued Oct. 19, 1999 to Cavadini, et al.). The present invention thus provides improvements in the compositions and methods described therein.

However as described in the '569 patent, there are two main issues in incorporating probiotic micro-organisms into foodstuffs. First, the foodstuff must be in a form which is palatable to a consumer. Second, the probiotic micro-organism must remain viable during both preparation and storage. The second issue is particularly problematic for foods that are intended for extended shelf lives at room temperature storage such as ready-to-eat (“RTE”) or breakfast cereal products. These cereal products, unlike fermented milks, are required to have long storage lives; for example at least a year while the cell counts for many probiotic micro-organisms may fall away completely within one or two days. This is particularly the case if the water activity of the foodstuff is above about 0.5.

Therefore there is a need for a ready-to-eat cereal product which contains a probiotic micro-organism, is highly palatable, and which is storage stable.

Fortunately, the art includes numerous descriptions of various encapsulation technologies whereby viable probiotic organisms are encapsulated in matrixes of various formulations comprising starches and/or lipids often with supplemental exotic ingredients. Generally, the methods of preparing such encapsulated pro-biotics are complicated often involving two or more levels of encapsulation.

Accordingly there is a continuing need for new encapsulated probiotic compositions that can be prepared by following relatively simple methods of preparation. Also, there is a need for encapsulated pro-biotic compositions that do not require selection of exotic or expensive ingredients. There is a need for such products to provide encapsulated viable pro-biotic cultures that can be stored for extended times at uncontrolled or room temperatures that nonetheless provide high levels of viable culture counts.

There is also a need for food products such as shelf stable products such as RTE cereals that include such encapsulated pro-biotics that can be made in mass quantities are commercially practical prices for use as nutritionally fortified. coated

Surprisingly, the above needs can now be satisfied employing a compound fat to encapsulate freeze dried viable pro-biotic cultures prepare by easily practiced method of preparation techniques. The compound fat encapsulates the probiotic cultures. The culture loaded compound fat can be applied to or otherwise incorporated into any number of dried food substrates such as RTE cereals to provide dried culture fortified food products. These dried culture fortified food products provide nutritionally significant quantities of viable pro-biotic cultures for the expected extended shelf lives of the RTE cereals.

### BRIEF SUMMARY OF THE INVENTION

In one product aspect, the present invention provides an sweetened fat or compound fat compositions that include and encapsulate high levels of viable live probiotic cultures. The compound fat encapsulated pro-biotic comprise a compound fat and sufficient amounts of freeze dried, viable probiotic cultures such as to provide at least 10³ to about 10⁹ colony forming unit's (“cfu”) per gram. The compound fat encapsulated pro-biotic has minimal moisture such as to provide a water activity (“A_{w}”) of less than about 0.3. The compound fat includes a fat ingredient, and a sugar ingredient in a weight ratio range of about 10:1 to about 10:50. The freeze dried culture is homogenously dispersed throughout the fat composition. The fat a melting point of about 25-45° C. (77-113° F.).

In another product aspect of one and the same invention, food products are provided comprising a food base and the compound fat encapsulated pro-biotic as a coating or portion or phase of the food product. The food base can include the compound fat encapsulated pro-biotic as a topical coating or phase or portion. The food base or foodstuff is dried and has a water activity ranging from about 0.1 to about 0.35. The weight ratio of food base to compound fat encapsulated pro-biotic ranges from about 100:1 to about 100:400. The pieces of the coated food base can be admixed with pieces of uncoated dried food base of the same or different composition to provide desired levels of pro-biotic fortification.

In its method of preparation aspect, the invention provides methods for preparing coated food comestible with an inoculated compound fat coating, comprising the steps of:
Providing a melted compound fat, comprising:
   A fat having a melting point ranging from about 25-45° C. (77-113° F.);
   Sugar; and,
   Having a temperature of 50° C. (122° F.) or less
   A water activity of 0.3 or less,
Admixing sufficient amounts of freeze dried viable pro-biotic culture to form a homogenously inoculated melted compound fat having 10³ to 10⁹ colony forming units per gram;
Applying the inoculated melted compound fat to at least a portion of a comestible base to form a coated comestible base having an inoculated compound fat coating in a weight ratio of comestible base to inoculated coating ranging from about 100:1 to 100:400; and
Cooling the coated comestible to below the melting point of the fat of the compound fat to form a compound fat coated comestible having encapsulated viable pro-biotic cultures.

### DETAILED DESCRIPTION OF THE INVENTION

The present invention relates to live or viable cultures such as yogurt and/or probiotic cultures encapsulated in a compound fats or loaded compound fats, to dried food products such as breakfast cereals coated with or containing such compound fats, and to their methods of preparation.

The invention provides a dried, ready-to-eat cereal product in the form of a gelatinized starch matrix which includes a coating or filling. The coating or filling contains a probiotic micro-organism. The probiotic micro-organism may be selected from one or more micro-organisms suitable for human or animal consumption and which is able to improve the microbial balance in the human or animal intestine.

Throughout the specification and claims, percentages are by weight and temperatures in degrees Centigrade unless otherwise indicated. Each of the referenced patents is incorporated herein by reference.

The principal ingredient is a compound fat. Such compound fats are sometimes equivalently referred to as compound coatings or as confectionery coatings. Compound fats are well known confectionery and food materials and a wide variety are commercially available. A good description of compound fats is given in U.S. Pat. No. 4,874,618 “Package Containing A Moisture Resistant Edible Internal Barrier” (issued Oct. 17, 1989 to Seaborne, et al.) or U.S. Pat. No. 4,820,533 “Edible Barrier For Composite Food Articles” (issued Apr. 11, 1989 to Seaborne, et al.).

While not all known compound fat formulations are suitable for use herein, the skilled artisan will have no difficulty in selecting suitable compound fats within the description of the invention herein.

Compound fat materials useful herein comprise a solid fat (i.e., a fat that is normally fat at room temperatures), typically a vegetable fat, and a sweetening ingredient typically sucrose. In preferred form, the present compound fat can comprise about 20% to 50%, preferably about 23% to 35% of the compound fat of a fat ingredient. In preferred form, the fat is a vegetable fat having a low melting point of ranging from about 25° C. (77° F.) to about 45° C. (113° F.). More preferably, the fat has a melting point ranging from about 30° C. (86° F.) to about 34° C. (93° F.). While both hydrogenated and non hydrogenated fats can be used herein to supply the fat ingredient, especially preferred for used herein is a non-hydrogenated fat (such as to minimize and trans fat constituent formed by hydrogenations) such as a fractionated palm oil fat having such a 30-34° C. (86-93° F.) melting point.

The compound fat materials useful herein can additionally include a nutritive carbohydrate sweetening ingredient in dry powder form. Broadly, the weight ratio of fat(s) ingredient to sugar(s) ingredient can range from about 10:1 to about 10:50. In preferred embodiments, the compound fat material can include about 55% to about 75%, preferably about 60% to 70% of the sugar ingredient. Inclusion of such a sugar ingredient has been found to be surprisingly useful in improving the workability or ease of application of the compound coating to a substrate as well as increasing the palatability of products to which the compound fat is applied or included. While sucrose is most commonly employed all or a portion of the sucrose can by substituted by other common sweeteners including fructose, dextrose glucose, corn syrup solids, maltose. Useful sugars can also include monosaccharides, disaccharides and their various degradation products. Examples of the pentoses, xylose, arabinose, glucose, galactose, mannose, fructose, lactose, maltose, brown sugar, dextrose. The particle size of the nutritive carbohydrate sweeteners should be sufficiently fine such as to minimize any gritty mouthfeel. Good results are obtained with particle sizes of 1-100 micron, preferably less than 50 micron.

The compound fat functions to encapsulate and protect viable pro-biotic cultures as well as to function as a convenient carrier for such pro-biotic constituents. The present loaded or fortified with viable pro-biotic culture compound fats can comprise sufficient amounts of dried viable pro-biotic culture such as to provide about 10³ to about 10¹² colony forming units pre gram (“cfu/g”) of loaded compound fat upon consumption. The probiotic micro-organism can be selected from one or more micro-organisms suitable for human or animal consumption and which is able to improve the microbial balance in the human or animal intestine. Such dried pro-biotic cultures are commercially available and are generally available in the form of freeze dried powders. Of course, some loss in the viability of the culture will occur during even good method of preparation practices as well as during distribution and storage. However, good results within the above cfu/g range are obtained when the fortified fat includes about 0.01% to about 0.1% of the freeze dried culture powder. In more preferred variations, the fortified compound fat comprises sufficient amounts of dried viable culture to provide about 10⁶ to about 10⁹ cfu/g of compound fat. In preferred form, the compound fat can comprise about 0.015% to about 0.1% of freeze dried viable pro-biotic culture. In most preferred form the compound fat can include about 0.01% to 0.03% freeze dried viable culture.

In preferred form the pro-biotic micro-organisms comprise or at least include at least one lactic and/or acetic acid bacteria, i.e., microbes that produce lactic acid, acetic acid and the like by decomposing carbohydrates such as glucose and lactose. In more preferred form, the cultures at least comprise one lactic acid forming culture. Morphologically, they are gram-positive, and are bacillus or micrococcus. They do not form an endospore, but are mobile. Physiologically, they are anaerobic, and are catalase-negative. The use sugar as the only source of energy. They convert sugar into lactic acid by 50% or more.

Categorically, the lactic acid bacteria includes: Lactobacillus, Leuconostoc, Pediococcus, Streptococcus and the like. Further they include bifidobacterium microbes which produce lactic acid by less than 50% of the glucose. Morphologically, the bifidobacterium belong to bacillus, and are grown into various kinds depending on the growing conditions. They are similar to the Lactobacillus, but they are acid non-resistant, and convert glucose into lactic acid and acetic acid at a ratio of 2:3.

The probiotic micro-organism may be selected from one or more micro-organisms suitable for human or animal consumption and which is able to improve the microbial balance in the human or animal intestine. Examples of suitable probiotic micro-organisms include yeasts such as Saccharomyces, Debaromyces, Candida, Pichia and Torulopsis, moulds such as Aspergillus, Rhizopus, Mucor, and Penicillium and Torulopsis and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Saccharomyces cereviseae, Bacillus coagulans, Bacillus licheniformis, Bacillus subtilis, Bifidobacterium bifidum, Bifidobacterium infantis, Bifidobacterium longum, Enterococcus faecium, Enterococcusfaecalis, Lactobacillus acidophilus, Lactobacillus alimentarius, Lactobacillus casei subsp. casei, Lactobacillus casei Shirota, Lactobacillus curvatus, Lactobacillus delbruckii subsp. lactis, Lactobacillus farciminus, Lactobacillus gasseri, Lactobacillus helveticus, Lactobacillus johnsonii, Lactobacillus reuteri, Lactobacillus rhamnosus (Lactobacillus GG), Lactobacillus sake, Lactococcus lactis, Micrococcus varians, Pediococcus acidilactici, Pediococcus pentosaceus, Pediococcus acidilactici, Pediococcus halophilus, Streptococcusfaecalis, Streptococcus thermophilus, Staphylococcus camosus, and Staphylococcus xylosus. The probiotic micro-organisms are preferably in powdered, dried form; especially in spore form for micro-organisms which form spores.

Preferred for use herein are cultures that include yogurt cultures such as Lactobacillus bulgaricus, Streptococcus thermiphilus, acidopilus, and mixtures thereof.

It will be appreciated that the viable pro-biotic culture is combined with the compound fat (as described in more detail below) while the culture is in a state of suspended animation or somnolence. That is, once freeze dried, the viable cultures are handled with care to minimize exposure to moisture that would reanimate the cultures since once reanimated, the cultures can experience high rates of morbidity unless cultured in a high moisture environment or medium. Likewise, the cultures are preferably handled to reduce exposure to high temperatures (especially when combined with exposure to moisture) to reduce morbidity.

The present compound fat are low moisture compositions, preferably essentially moisture free (i.e., less than 0.5%) and importantly have a water activity ranging from about 0.1 to about 0.3. Selection of such low water activity compound fat compositions is important to providing encapsulated culture compositions that provide high levels of viable encapsulated pro-biotic cultures at room temperature storage conditions for the expected 6-12 month storage conditions required for shelf stable food products distribution such as for breakfast cereals.

If desired, the compound fat can additionally include about 0.5% to about 10%, preferably about 3-7%, of non fat dry milk solids.

The compound fat can additionally include adjuvants to improve the flavor, appearance and nutritional properties of the compound coating.

Useful materials include, for example, colors, flavors, high potency sweeteners, preservatives, nutritional fortifying ingredients and mixtures thereof. If present, such optional materials can collectively comprise from about 0.01% to about 25% by weight of the present products, preferably about 1% to 10%.

In highly preferred embodiments, the present products comprise a calcium ingredient of defined particle size in an amount effective to provide the desired calcium enrichment. The present food products find particular suitability for use in the inclusion of dried marbits as ingredients in child oriented Ready-to-eat cereal products. Children are in particular need of additional calcium. Good results are obtained when the present aerated confectionery compositions comprise sufficient amounts of calcium ingredients to provide the total calcium content of the composition to from about 50 to 2500 mg per 28.4 g (1 oz) serving (dry basis) (i.e., about 0.15% to 10% by weight, dry basis) of calcium, preferably about 100 to 1500 mg calcium per 28.4 g (1 oz.), and more preferably about 200 to 1500 mg calcium/oz.

Useful herein to supply the desired calcium levels are calcium ingredients that supply at least 20% calcium. Preferred for use herein are calcium ingredients selected from the group consisting of food grade calcium carbonate, ground limestone, calcium phosphate salts and mixtures thereof.

More preferably, any insoluble component such as mineral fortifying ingredient (e.g. calcium carbonate or a calcium phosphate salt for calcium fortification) is added in the form of a fine powder having a particle size such that 90% has a particle size of less than 150 micron, preferably 100 μm or less in size and for best results under 10 microns.

Flavor ingredients can include any fat soluble flavorant. Also, the flavor ingredient can include minor amounts (e.g., about 0.1% to 1%) of edible organic acids (and/or their salts) such as citric acid (and/or sodium citrate), lactic acid, malic acid, acetic acids, and mixtures thereof to provide tartness. Colorants can include, for example, TiO₂ to provide a white coating (to moderate the discoloration of the dried microorganism, for example). Of course, certain ingredients, e.g., calcium carbonate, can provide not only nutritional properties but also improve color.

The compound fat substrate preferably contains antioxidants (e.g. about 1-400 ppm of the fat ingredient) as a preservative to reduce the action of oxygen on sensitive micro-organisms.

The compound fat encapsulating the micro-organisms of the present invention formulated as described above finds particular suitability for use as an easy and cost effective way of delivering viable cultures in a dry ready-to-eat product. Accordingly, in one aspect, this invention provides a dried, shelf stable product comprising a spreadable dry coating or filling containing a probiotic micro-organism as a useful intermediate product.

In another product aspect of the present invention, food products are provided comprising a food base and the compound fat encapsulated pro-biotic intermediate product as a coating or portion or phase of the composite food product. The food base can include the compound fat encapsulated pro-biotic as a topical coating or phase or portion. The food base or foodstuff is dried and has a water activity ranging from about 0.1 to about 0.35. The weight ratio of food base to compound fat encapsulated pro-biotic ranges from about 100:1 to about 100:400. The pieces of the coated food base can be admixed with pieces of uncoated dried food base of the same or different composition to provide desired levels of pro-biotic fortification.

The present compound coating encapsulated microorganisms find particular suitability for use as a phase or portion or layer, especially a coating, for food base such as ready-to-eat or also referred to as breakfast cereals. While in the present description particular attention is such RTE cereal products, the skilled artisan will appreciate that the present invention finds utility in a wide variety of dried (i.e., having an A_{w} ranging from about 0.1-0.35) shelf stable ready-to-eat composite products (or “comestibles” herein) intended to be distributed and sold at room temperatures. Such comestibles can include cereal bars, cookies, biscuits, pretzels, fried grain based snacks, nuts, and mixtures thereof intended for human consumption. Of course, dried animal feed products such as for live stock and domestic animals such as dogs and cats are also contemplated herein.

Breakfast cereal products are well known and the art is replete with references that describe their formulation and methods of preparation. Generally, such products are prepared from dried cooked cereal or gelatinized starch doughs. The doughs include one or more these starch ingredients. Suitable starch ingredients are, for example, grain flours such as corn, rice, wheat, beets, barley, soy and oats. Also mixtures of these flours may be used. The flours may be whole flours or may be flours which have had fractions removed; for example the germ fraction or husk fraction may be removed. Rice flour, corn flour and wheat flour are particularly suitable; either alone or in combination. The starch source will be chosen largely on the basis of the nutritional value, palatability considerations, and the type of cereal product desired.

The cooked cereal dough can include one or more ingredients intended to improve the appearance, flavor or nutritional properties such as vitamins, minerals, flavoring agents, coloring agents, antioxidants.

If desired, sources of insoluble fiber may also be included; for example wheat bran, corn bran, rice bran, rye bran and the like. Further, if desired, a source of soluble fiber may be included, for example, chicory fibers, inulin, fructooligosaccharides, soy oligosaccharides, oat bran concentrate, guar gum, carob bean gum, xantham gum, and the like. Preferably the soluble fiber selected is a substrate for the micro-organism selected, or such that the soluble fiber and micro-organism form a symbiotic relationship for promoting beneficial effects. The maximum level of soluble fiber is preferably about 20% by weight; especially about 10% by weight. For example, for pet foods, chicory (an inexpensive source of inulin) can be included to comprise about 1% to about 20% by weight of the feed mixture; more preferably about 2% to about 10% by weight.

Depending upon the desired form of the cereal product, the starch content of the feed mixture may be varied. For example, for an expanded cereal product, the feed mixture preferably includes up to about 80% by weight of starch. However, for a flaked product, it is not necessary to use large amounts of starch in the feed mixture since it is possible to flake an unexpanded product.

It has been found that compound fat encapsulated probiotic micro-organisms remain viable for extended periods of time when formulated into a coating on or as a filling in a dried RTE cereal product. This is surprising since probiotic micro-organisms ordinarily die off rapidly. This is particularly the case for dried, cooked foods which generally have a water activity of above about 0.5; levels at which probiotic micro-organisms ordinarily die off rapidly. Therefore the invention offers the advantage of a ready-to-eat cereal product which is highly palatable and which contains a shelf stable source of probiotic micro-organisms.

The food base can be in the form of a dried pet food, breakfast cereal, an infant cereal, or a convenience food such as a cereal bar. For human foods, the food base is a breakfast cereal fabricated from a cooked gelatinized starch matrix or cereal dough and is preferably in the form of flakes, shreds, biscuits, squares and puffed pieces. Especially preferred for use herein are flakes fabricated from cooked cereal coughs, e.g., corn flakes and/or wheat flakes. For pet foods, the gelatinized starch matrix is preferably in the form of kibbles or pieces. The gelatinized matrix is preferably produced by extrusion cooking a starch source which can optionally include minor amounts of one or more protein ingredients.

In one preferred embodiment, breakfast cereal flakes are provided with an exterior coating on at least a portion of their surface of the compound coating encapsulating the dried viable microorganisms. In more preferred form, the flakes are provided with a coating

### Method of Preparation

In a further aspect, this invention provides methods for preparing food comestibles including an inoculated compound fat coating.

The methods can include a step of providing a low moisture (A_{w}≦0.3) melted compound homogeneously admixed with dried pro-biotic cultures. As described above, the compound fat includes a fat constituent having a melting point ranging from about 25-45° C. (77-113° F.). The compound fat can be heated to its melting point or slightly above (i.e. preferably mono more than about 5° C. (41° F.) above its melting point) to provide a melted compound fat. In other less preferred variations, compound fats having lower melting points (e.g., up to 30° C. (86° F.)) can be heated up to about 50° C. (122° F.) before admixture with the dried culture. In a preferred variation, the culture is a freeze dried culture. Also, preferably the culture is chilled to below 10° C. (50° F.) prior to admixture with the melted fat. Importantly, the compound fat is low in free moisture (i.e., A_{w}≦0.3) so as to minimize exposure of the dried viable culture to minimize the waking up of the culture from its somnolence state. The dried culture is admixed to the melted fat along with any supplemental ingredients such as lactic acid (for flavor) to form. In preferred form, this step can include the sup-steps of proving a melted compound fat, and admixing therewith sufficient amounts of freeze dried viable pro-biotic culture are admixed to form a homogenously inoculated melted compound fat having 10³ to 10⁹ colony forming units per gram.

Thereafter, the methods can include a step of combining the melted compound fat admixed with the viable dried culture with a dried food base (i.e., having an A_{w} ranging from about 0.1 to 0.35) to form a warm composite food comestible. In preferred variations, the food base includes quantities of RTE cereal pieces especially in flake form. In a preferred practice technique, a quantity of RTE cereal flakes are fed to an enrober or other suitable coating device and a quantity of the melted compound fat is applied to the RTE cereal flakes. In the confectionary art, this coating step is sometimes referred to as a “grossing” step. In a preferred variation, a the quantity of cereal flakes are provided having a temperature above the melting point of the compound fat, e.g. warmed to about 50-60° C. (122-140° F.). To the warmed food base pieces, the melted compound fat can be applied in the form of a spray to provide a topical coating of the melted compound fat. Optionally, but preferably, the spray is assisted by applying the melted compound fat through a spray nozzle with a co-spray of air. The mixture of warm food base and melted compound fat is tumbled for time sufficient to provide an even coating of the compound fat on the food base pieces. Good results are obtained, for example, when the tumbling is continued for about 20-40 minutes. The tumbling, of course, is to be practiced to balance the evenness of the resulting coating against the undesirable production of cereal fines caused by the tumbling action. In one variation, the weight ratio of compound fat to food base can range from about 1:1 to about 4:1, preferably about 2.5:1 to 2.5: fat to cereal base. In one variation the flake has a thickness of 1 mm and a top coating of 1-2 mm and a bottom coating of like thickness.

In another example, the food base pieces can be fed into a fluidized bed onto which the melted compound fat and pro-biotic culture mixture is sprayed thereon. Alternatively, the pieces can be fed into a rotary coater into which the mixture is sprayed. As a further alternative, the pieces can be caused to fall in a curtain and the melted compound fat and dried culture coating mixture sprayed onto the curtain.

In other variations, the compound fat with culture can be applied to only a portion of the food base. For example, the food base can be a cookies, a granola bar or other cereal bar having at least one upper major face or surface and to which the compound fat is applied as a topical coating. In another variations, the compound fat is formed as a base layer to which granola or other food base is applied to form a two layer bar. In other variations, the food base includes RTE cereal pieces, e.g., biscuits having opposed major surfaces, to which the coating is applied to only one major surface. In still other variations, the compound fat can be a filling layer or portion such as in a composite cookie having upper and lower cookie pieces, e.g., disks, with an intermediate filling layer provided by the compound fat with viable culture encapsulated therein. For a filled cereal product, the mixture of the probiotic and micro-organism and melted compound fat is filled into the central bore of each piece. It will be appreciated however that regardless of the application technique, exposure of the dried culture to moisture is to be minimized.

Thereafter, the present methods can provide a tempering step to allow the compound coating to cool from the application temperatures (above the meting point of the constituent fat) of the grossing step to below the melting point of the compound fat to solidify thereby forming a solid coating or portion on or in the food base. In a preferred form, the warm composite food comestible is allowed to temper at below about 25° C. (77° F.), and preferably between 10-20° C. (50-68° F.), for 50 to 400 minutes, preferably about 100 to 250 minutes to form a compound fat coated comestible having encapsulated viable pro-biotic cultures. In preferred form, the tempering step is practiced quiescently, i.e., without or with only mild agitation or movement.

Especially in those embodiments where the compound fat forms an exterior coating, the present methods of preparation can further include a polishing step. The polishing step includes applying a polish coating to provide a polished or polish top coat to the compound fat base coating so as to reduce abrasion loss of the compound fat coating during any subsequent handling of the product. In a preferred variation, a polishing solution is applied to the tempered coated RTE cereal flakes whereby loss of the coating in the packaging or carton is reduced (i.e., to reduce “fines”). The polishing solution can be an oil slurry of starch having low moisture contents. The oil content can range from about 85% to 95% liquid edible oil (i.e., a lipid ingredient that is liquid at room temperatures), about 0-3% moisture, preferably about 2-3% moisture and the balance starch such as corn starch. In preferred form, the liquid oil is winterized to form a clear chilled oil. The oil/starch slurry is preferably applied chilled to under 20° C. (68° F.) and is applied to the still chilled tempered coated pieces in, for example, an enrober. Chilled conditioned air (e.g., 5-20° C. (41-68° F.)) is supplied to the enrober to remove the moisture, if any, associated with the polishing oil/starch slurry. The ratio of coated base to polishing slurry can range from about 100:1 to about 100:10, preferably about 100:2 to about 100:5.

The present methods of preparation can further include a sealing step. The sealing step includes applying a sealing coating to improve resistance to moisture pick-up. Improved resistance to moisture pick-up provides advantages of minimizing the loss of viable culture counts upon extended storage. In more preferred embodiments, the present methods include both the polish step and the sealing step. The sealing step includes applying a moisture barrier edible material.

In one variation, the sealing step involves applying an edible shellac to the polished compound fat coated food base. For example, a sealing solution of edible shellac is dissolved in undenatured ethanol (at 10-30% solids). The shellac solution is applied chilled (0° C.-20° C.) (32-68° F.) to chilled polish coating bearing compound fat coated cereal base pieces. In preferred form, for convenience, the tempering, polishing step and sealing step are all performed in a chill room. In other variations, the sealing or moisture barrier edible material can be those blends of edible shellac and other materials as are described in the patents to Seaborne, et al.; namely: U.S. Pat. No. 4,710,228 “Edible Coating Composition And Method Of Preparation” (issued Dec. 1, 1987); or U.S. Pat. No. 4,810,534 “Methods For Preparing A Low Water Permeability, Edible Film” (issued Mar. 7, 1989); U.S. Pat. No. 4,820,533 “Edible Barrier For Composite Food Articles” (issued Apr. 11, 1989); or U.S. Pat. No. 4,874,618 “Package Containing A Moisture Resistant Edible Internal Barrier” (issued Oct. 17, 1989). The ratio of compound fat coated food base to edible shellac blend can range from about 100:1 to 100:5.

Conveniently, the edible shellac sealing solution is applied to the same enrober after completion of the polish application step. Chilled or conditioned air is applied to or continued to remove or evaporate the alcohol.

The food base pieces are dried to a moisture content below about 10%. For breakfast cereals, moisture contents of about 1% to about 3% by weight are preferred.

The dried, ready-to-eat cereal product so prepared conveniently contains about 10⁴ to about 10¹⁰ cfu/g of the probiotic micro-organism of the dried cereal product; preferably about 10⁶ to about 10⁸ cfu/g of the probiotic micro-organism.

If desired, however, the coated RTE cereal product function as an intermediate product and the intermediate product can be blended with uncoated RTE cereal base. In a preferred technique, smaller quantities of coated comestible base pieces can be prepared in one facility or location, packaged in bulk and shipped to a second facility for blending with larger quantities of uncoated cereal base of similar or different cereals. For example, quantities of the dried coated pro-biotic culture containing cereal product can be blended with in a ration of about 100:1 to about 100:1000, preferably about 100:100 to about 100:500. In more preferred form, the coated comestible base are packaged and shipped under refrigerated conditions to assist in providing high levels of culture viability in the intermediate. In this practice, the intermediate product is purposefully overfortified with culture such as to provide the finished blended product with desired levels of fortification. For example, if the intended finished product is desired to have about 2×10⁹ cfu/g, then the intermediate product can be prepared to have about 10¹⁰ cfu/g such that the intermediate fortified food product base can be admixed with unfortified RTE cereal base at a level of about 1:4 fortified base to unfortified base to provide a finished blended product having desired levels of culture.

The dried cereal product can further include additional added particulates such as dried fruit, nuts, other cereals, dried milk produce (such as dried yogurt etc) can be dry mixed with or agglomerated with the coated cereal. If desired, the dried cereal may be further coated with protective agents or flavoring agents, or both. This can also be carried out prior to or during coating or filling of the dried pieces with the mixture of the probiotic and micro-organism and carrier substrate provided that measure are taken to minimize exposure of the viable cultures to moisture that would awaken the cultures prematurely.

The culture fortified food products including RTE cereals are intended for distribution, storage and sale are room temperatures for extended times (up to 9 months) while nonetheless providing high levels of viable culture fortification (although some loss over time of culture counts can be expected).

The amount of the dried, ready-to-eat cereal product to be consumed by the human or animal to obtain a beneficial effect will depend upon the size and age of the human or animal. However an amount of the dried, ready-to-eat cereal product to provide a daily amount of about 10⁶ to about 10¹² cells of the probiotic micro-organism would usually be adequate.

Some degree of care is needed to properly test for the presence of and measure the quantity of viable cultures in the finished product. In preferred form, the following procedure is followed to ensure accuracy.

### Media

The assay is conducted by using two isolation agars, MRS agar and M17 agar made according to manufactures instructions. Both of these medias are available from Difco although the M17 is a broth so agar, at 15 g per liter, has to be added before autoclaving.

### Slurry Sample Prep

The slurry sample should be soften long enough at 40° C. (104° F.) so it can be thoroughly stirred. After stirring, a 1:10 dilution should be made in pre-warmed, 40° C. (104° F.), dilution blanks. To ensure lactic cell release into the dilution blank the 1:10 pre-warmed dilution bottle needs to sit at 40° C. (104° F.) for 10 minutes before plating. After 10 minutes thoroughly shake the 1:10 dilution and prepare the appropriate dilutions to get plates with 30 to 300 colonies on them for accurate counting. The additional dilution blanks do not need to be pre-warmed. The appropriate dilutions should be plated in both recovery agars and incubated at 35° C. (95° F.) for 72 hours before counting. The MRS agar is incubated anaerobically and the M17 agar aerobically.

### Coated Flake Prep

Only coated flakes should be tested for lactic recovery counts. Pre-warmed, 40° C. (104° F.), dilution blanks should be used to make the initial 1:10 dilution. After weighing, the 1:10 pre-warmed dilution bottle should sit at 40° C. (104° F.) for 10 minutes. After the 10 minute cell release step, the 1:10 sample should be thoroughly ground in a Waring blender to finish the lactic cell release. After blending, prepare the appropriate dilutions to get plates with 30 to 300 colonies on them for accurate counting. The additional dilution blanks do not need to be pre-warmed. The appropriate dilutions should be plated on both recovery agars and incubated at 35° C. (95° F.) for 72 hours before counting. The MRS agar is incubated anaerobically and the M17 agar aerobically.

### Calculation:

The M17 agar should favor the Strep count and the MRS agar should favor the Lactobacillus count. Counts from the two agars cannot be added to determine the total lactic count because both the Strep and the Bacillus have the potential to grow on both agars. Typical colonies from both agars should be confirmed microscopically to determine the total Strep and Bacillus count and then these are added together to determine the total lactic count.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A compound fat, comprising:
an edible fat having a melting point ranging from about 25-45° C. (77-113° F.);
a nutritive carbohydrate sweetening ingredient having a particle size of less than 50 micron in a weight ratio of fat ingredient to a sugar ingredient range of about 10:1 to about 10:50; and,
sufficient amounts of freeze dried, viable pro-biotic cultures homogeneously dispersed there through such as to provide at least 10⁶ to about 10⁹ colony forming unit's (“cfu”) per gram,
wherein the compound fat has a water activity (“A_{w}”) of less than 0.3.

2. The compound fat of claim 1 having a moisture content of less than 0.5%.

3. The compound fat of claim 2 wherein at least a portion of the fat is non-hydrogenated.

4. The compound fat of claim 3 wherein at least a portion of the nutritive carbohydrate sweetening ingredient is sucrose.

5. The compound fat of claim 4 wherein the viable pro-biotic cultures includes a lactic acid generating organism.

6. The compound fat of claim 5 wherein the viable pro-biotic culture includes a yogurt culture.

7. The compound fat of claim 6 comprising about 0.01% to 0.15% by weight of freeze dried viable culture.

8. The compound fat of claim 7 wherein the fat ingredient is free of hydrogenated vegetable fats.

9. The compound fat of claim 8 wherein at least a majority of the nutritive carbohydrate sweetening ingredient is sucrose.

10. The compound fat of claim 9 additionally comprising about 0.01% to about 0.2% of an edible organic acid or its sodium or potassium salt.

11. The compound fat of claim 10 wherein at least a portion of the fat ingredient is a fractionated palm oil.

12. The compound fat of claim 11 additionally comprising about 0.1% to 10% of a calcium ingredient having a particle size of less than 50 microns.

13. A food product, comprising:
a dried food base having a water activity ranging from about 0.1 to about 0.35; and
a compound fat including an edible fat having a melting point ranging from about 25-45° C. (77-113° F.), a nutritive carbohydrate sweetening ingredient having a particle size of less than 50 micron in a weight ratio of fat ingredient to a sugar ingredient range of about 10:1 to about 10:50, and sufficient amounts of freeze dried, viable pro-biotic cultures homogeneously dispersed there through such as to provide at least 10⁶ to about 10⁹ colony forming unit's (“cfu”) per gram in a compound fat encapsulated pro-biotic, said compound fat encapsulated pro-biotic being a coating or portion or phase of the food product;
wherein the compound fat has a water activity (“A_{w}”) of less than 0.3; and
the weight ratio of food base to compound fat encapsulated pro-biotic ranges from about 100:1 to about 100:400.

14. The food product of claim 13 wherein the compound fat has a moisture content of less than 0.5%.

15. The food product of claim 14 wherein at least a portion of the compound fat encapsulated pro-biotic is applied to the exterior of the dried food base.

16. The food product of claim 15 wherein at least a portion of the food base is in the form of ready-to-eat cereal pieces.

17. The food product of claim 16 wherein at least a portion of the ready-to-eat cereal pieces is in the form of flakes.

18. The food product of claim 17 additionally comprising uncoated pieces of ready-to-eat cereal forming a blend of coated and uncoated cereal pieces.

19. The food product of claim 18 wherein at least a portion of the uncoated cereal pieces are in the form of flakes.

20. The food product of claim 15 wherein the food base includes at least one member selected from the group consisting of biscuits, cereal bars, candies, cookies, dried fruits, fried grain based snacks, nuts, pretzels and mixtures thereof.

21. The food product of claim 20 wherein at least a portion of the viable pro-biotic cultures is a yogurt culture.

22. The food product of claim 15 wherein the food base is a chocolate flavored ready-to-eat cereal.

23. The food product of claim 20 in the form of a bar.

24. A method of preparing coated food comestible with an inoculated compound fat coating, comprising the steps of:
A. providing a melted compound fat, comprising:
a fat having a melting point ranging from about 25-45° C. (77-113° F.);
sugar; and,
having a temperature of 50° C. (122° F.) or less
a water activity of 0.3 or less,
B. admixing sufficient amounts of freeze dried viable pro-biotic cultures to form a homogenously inoculated melted compound fat having 10³ to 10⁹ colony forming units per grams;
C. combining the inoculated melted compound fat with a comestible base to form a composite comestible base having an inoculated compound fat portion in a weight ratio of comestible base to inoculated compound fat portion ranging from about 100:1 to 100:400; and
D. cooling the coated comestible to below the melting point of the fat of the compound fat to form a compound fat coated comestible having encapsulated viable pro-biotic cultures.

25. The method of claim 24 further comprising: chilling the freeze dried viable pro-biotic cultures to a temperature below 10° C. (50° F.).

26. The compound fat of claim 1 wherein the freeze dried viable pro-biotic cultures are in spore form.
